(19) United States
(12) Patent Application Publication
(10) Pub. No.: US 2024/0020681 A1
(43) Pub. Date: Jan. 18, 2024

(54) DIGITAL TOKENS USING BLOCKCHAIN

(71) Applicant: Eric FINNERUD, Lawrenceville, GA (US)

(72) Inventor: Eric FINNERUD, Lawrenceville, GA (US)

(21) Appl. No.: 18/222,772

(22) Filed: Jul. 17, 2023

Related U.S. Application Data
(60) Provisional application No. 63/389,715, filed on Jul. 15, 2022.

(51) Int. Cl. G06Q 20/36; G06Q 20/38

(52) U.S. Cl. CPC G06Q 20/3672; G06Q 20/389; G06Q 20/3825

(57) ABSTRACT

A computer-implemented method of issuing tokens using a blockchain, wherein the method is performed by a platform provider and comprises: obtaining, from an authorised user, a digital content item; arranging for the storage the digital content item and/or sending the digital content item to a storage provider for storage by the storage provider; generating one or more digital tokens, each digital token comprising data representing and/or associated with the digital content item; arranging for the submission of one or more transactions to a blockchain, each transaction comprising data associated with a respective one of said one or more digital tokens; providing an online platform to users to view, purchase, trade and/or sell the one or more digital tokens.

### TECHNICAL FIELD

The present disclosure relates to a method for issuing digital tokens using a blockchain, wherein ownership of a digital token grants access to associated digital content.

### BACKGROUND

A non-fungible token (NFT) is a digital asset that represents a real-world asset. NFTs are typically stored on a blockchain. NFTs are created in a process known as “minting” and can be traded amongst users.

### SUMMARY

According to one aspect disclosed herein, there is provided a computer-implemented method of issuing tokens using a blockchain, wherein the method is performed by a platform provider and comprises: obtaining, from an authorised user, a digital content item; arranging for the storage the digital content item and/or sending the digital content item to a storage provider for storage by the storage provider; generating one or more digital tokens, each digital token comprising data representing and/or associated with the digital content item; arranging for the submission of one or more transactions to a blockchain, each transaction comprising data associated with a respective one of said one or more digital tokens; providing an online platform to users to view, purchase, trade and/or sell the one or more digital tokens.

According to another aspect disclosed herein, there is provided a computer-implemented system comprising: a platform processor configured to conduct the method of any one of claims 1 to 24, an authorised user configured to provide a digital content item to the platform processor for minting of the digital content item into a token.

In general, ownership of a digital token grants the owner (or holder) of the token access to (and/or other benefits associated with) the digital content. Thus the platform provider 302 facilitates the access to digital content by providing an online platform the minting and trading of tokens representing digital content. The online platform provides a convenient, easy-to-use and efficient way for users to interact to mint, purchase, sell and trade tokens representing digital content, such as songs, videos and artwork. The online platform provides a single platform for content creators (e.g. artists) and buyers to come to for all of their interactions.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram for issuing tokens using a blockchain,

FIG. 4 is another schematic block diagram for issuing tokens using a blockchain,

FIG. 5 shows an example flow for issuing tokens, and

FIG. 6 shows an example flow for trading tokens.

### DETAILED DESCRIPTION OF EMBODIMENTS

### 1. Digital Tokens for Digital Content

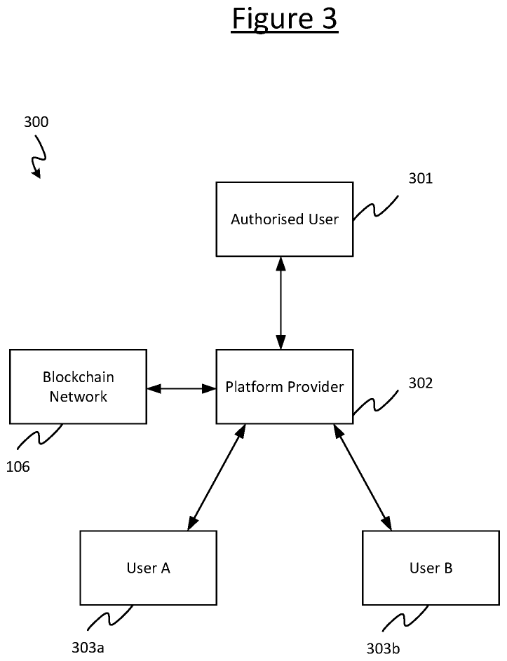

FIG. 3 illustrates an example system 300 for issuing digital tokens representing ownership and/or access rights for digital content, such as an audio file (e.g. a music track). The system 300 includes an authorised user 301. The authorised user 301 has access to digital content. The authorised user 301 may be the initial creator of the digital content. The digital content 30 may comprise one or more images (such as digital artwork), one or more audio files (such as a music album), one or more videos (such as a film or documentary), etc. The system 300 also includes a platform provider 302. The platform provider 302 hosts an online platform for creating, listing and trading digital tokens. The platform provider 302 may be an individual user, a group of users, an organisation, a company, a government body, etc. The system 300 also includes one or more end users 303 who desire to view, purchase, sell, trade, etc. the digital tokens. Each entity (authorised user 301, platform provider 302, end user 303) may be configured to perform any of the actions described below as being performed by Alice 103 and/or Bob 103b. Also shown as part of the system 300 is one or more nodes 104 of a blockchain network 106.

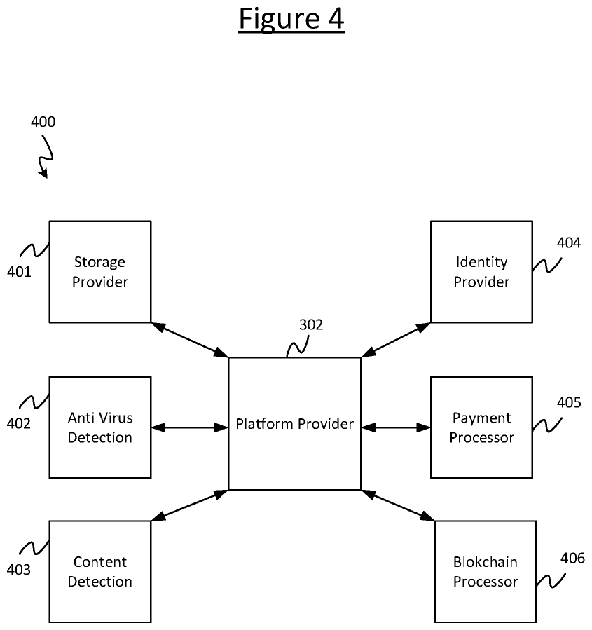

FIG. 4 illustrates another example system 400 for issuing digital tokens. Whilst not shown in FIG. 4, the system 400 also includes the authorised user 301 and end users 302. In addition to the platform provider 302 that hosts (i.e. controls, manages, etc.) the online platform, the system 400 includes the following components/entities: a storage provider 401 (e.g. Amazon Web Services or S3) configured to store digital content, an anti-virus detection module 402 (e.g. ClamAV) configured to scan digital content for computer viruses, a content detection module 403 (e.g. Rekognition) configured to scan digital content for one or more of illegal, illicit, copyright-protected material, an identity provider 404 configured to provide and/or verify a user's identity, a payment processor 405 configured to process user-to-user payments and/or platform-to-user payments, and a blockchain processor 406 configured to process (e.g. generate, obtain, store blockchain transactions). The blockchain processor 406 may comprise a wallet application, or a wallet application may be provided separately, e.g. each user may operate a wallet application. Whilst each component/entity is shown as separate, one or more components/entities may be combined. Similarly, one or more components/entities may be operated by (e.g. comprised by) the platform provider 302. Each component/entity may be embodied in hardware or software.

The authorised user 301 sends digital content (e.g. a song) to the platform provider 302. For example, the digital content may be uploaded to (i.e. submitted to) the online platform. The platform provider 302 may store the received digital content in storage, e.g. internal storage, cloud storage, etc. Additionally or alternatively, the platform provider 302 may send the digital content to the external storage provider 401 for storage, e.g. in cloud storage. Image and/or video data associated with the digital content (such as a thumbnail, album artwork, etc.) may also be sent by the authorised user 301 and stored by the platform provider 302 and/or storage provider 401.

The platform provider 302 and/or the storage provider 401 may, before accepting the digital content for token generation, long term storage, and/or storage (i.e. before storing the digital content in memory) perform checks on the digital content. For example, the digital content may be checked by the anti-virus detection module 402 for viruses or other types of harmful software. The digital content may be checked for illegal, illicit, harmful, or abusive content by the content detection module 403. The content detection module 403 may check for copyright infringement. If any of the checks fail, the digital content may be rejected by the platform provider 302.

Preferably, the platform provider 302 provides an authorised link to the authorised user 301, wherein the link enables the authorised user 301 to upload their digital content directly to the external storage provider 401. Preferably, the link is authorised by the platform provider 302. More preferably, the link is signed by the platform provider 302 thereby enabling the authorised user to directly upload the relevant data. The external storage provider 401 provides a trigger and/or notification such that an upload has occurred. The trigger or notification is received or obtained by the platform provider 302 and added to a queue for processing.

Preferably the trigger/notification comprises a further link to the content uploaded.

Advantageously, allowing of direct content upload by the authorised user 301 through use of the authorised link allows for more efficient bandwidth usage (such that the platform provider 302 does not need to receive the data and forward it on). A further advantage of the authorised link, in addition with the message queueing, is that if the platform provider 302 is under heavy load (for any reason), uploading will still be able to occur and the processing of the content (for anti-virus, illegal content, etc) will also still occur, just delayed when more computing resources are freed or added.

Advantageously, conducting the digital content checks (such as the anti-virus and/or illegal content scanning) before any token is generated reduces the likelihood any tokens will need to be with recalled, burnt, or otherwise made unusable. This therefore reduces the need for any further processing to do any such recalling or burning and results in saving of CPU time, reduction in blockchain storage space, and other improvement of computer resource usage.

The platform provider 302 generates one or more digital tokens representing ownership and/or access rights of the digital content. The number of tokens may be decided by the authorised user 301, e.g. as data input to the online platform. Each digital token may comprise data representing or otherwise associated with the digital token, e.g. to identify the digital content. Each token may contain a unique identification code. The token may contain a description (or a hash of or reference to) the terms and conditions of the token. The token may contain metadata (or a hash of or reference to) relating to the digital content such as, for example, the content creator, the creation date, the duration of the content, the file type, etc.

The tokens are listed on the online platform, e.g. the token may be shown as or associated with the stored image/video data, such as an album cover. The online platform allows users 303 to view available tokens and the represented digital content. Information such as the token price may be provided.

The tokens are submitted to the blockchain 150 either directly by the platform provider 302 or via the blockchain processor 406. More specifically, each token is included in its own output (UTXO) of a blockchain transaction. One or more tokens may be included in the same transaction, or each token may be included in a separate transaction. Each token output (i.e. an output containing a token) is locked to a public key of the authorised user 301 and/or a public key of the platform provider 302. This dictates who has control of transferring the tokens. That is, whether it is the authorised user 301 or the platform provider 302 who must enact the transfer, or both.

In some examples, the platform provider 302 may require that the authorised user 301 submits a payment before generating the token(s). The platform provider 302 may use the payment processor 405 to facilitate the payment. The online platform may be configured to connect the authorised user 301 and the payment processor 405. The authorised user 301 may make the payment using a wallet application. That is, the payment may be in a digital asset such as a cryptocurrency.

The platform provider 302 may require identity information of the authorised user 301 and/or perform an identity check on the authorised user 301 before generating the token(s). The online platform may be configured to allow the user 301 to provide identity information. The online platform may use the identity provider 404 to facilitate the identity check.

An end user 303 (e.g. user A 303a) may submit a request to the platform provider 302, via the online platform, to purchase a token. In response, the platform provider 302 may transfer a token to the end user 303. That is, a transaction may be submitted to the blockchain 150 that spends a token output (i.e. an output of an existing transaction that contains a token) and has a token output now locked to the end user's public key. The output may also be locked to the platform provider's public key. Having an output containing a token and locked to a public key is interpreted as the owner of the public key owning the token and hence having the associated ownership and/or access rights of the digital token represented by that token. As before, the blockchain processor 406 may be used to submit the blockchain transaction to the blockchain network 106.

The platform provider 302 may provide access to the digital content to the new token owner, e.g. user A 303a. Access may be provided via the online platform. That is, the end user 303 may view, listen or watch the content via the platform. In some examples, the platform provider 302 and/or the storage provider 401 may send the digital content to the end user 303 and/or allow the end user 303 to download the digital content to local storage.

The end user 303 may purchase the token by submitted a payment via the online platform. The online platform may facilitate the payment by connecting the end user to the payment processor 405. The payment platform 302 and/or the payment processor 405 may send some or all of the payment to the authorised user 301. Payments may be made in FIAT or using the blockchain's native digital asset.

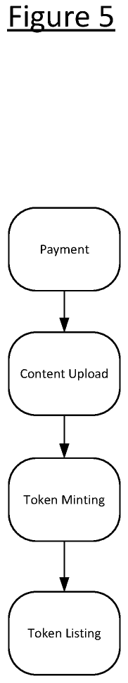

FIG. 5 shows an overview of an example process for minting a token. The process begins with an authorised user 301 making a payment, via the online platform, to the platform provider 302 to mint tokens. The authorised user 301 uploads the digital content, via the online platform, to the platform provider 302. The platform provider 302 mints one or more tokens, which are listed on the online platform.

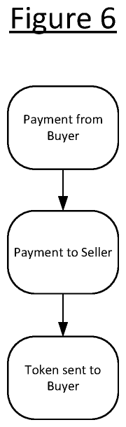

FIG. 6 shows an overview of an example process for trading a token. A buyer (e.g. user A 303a) makes a payment, via the online platform, to the seller (e.g. the authorised user 301). The payment may instead be to the platform provider 302 who coordinates payment to the seller. Upon successful payment, the token is transferred to the buyer.

Preferably, the platform provider 302 additionally provides a digital distribution process for a user 301 uploading their digital content (and in particular their music and artwork). As used herein, digital distribution, is the delivery or distribution of digital media content such as audio, video, e-books, video games, and other software through use of other platform providers. For example, the digital distribution process of the platform provider provides any audio related files to a music distribution company such as The Orchard™ owned by Sony™. Optionally, the platform provider 302 directly interfaces with music streaming companies such as Spotify™, iTunes™, Bandcamp™, or Tidal™. These music distribution companies and music streaming and/or purchasing companies are preferably collectively known as distribution outlets, as these companies provide additional points from which the digital goods are sold or distributed.

Digital outlets optionally provide additional services beyond monetisation of the digital content. For example, digital outlets provide methods for content owners to monitor for any copyright infringement and notify an owner when any such infringement occurs. An example infringement monitoring system is Google's (TM) Content ID system.

Advantageously, the digital distribution process enables a digital content owner greater flexibility in their digital content distribution as well as the ability to track the different platforms their digital content is available on. Also advantageously, these distribution outlets provide further technical features for the digital content owners. For example, where the digital outlet provides copyright infringement monitoring, the digital content owner is able to use said monitoring features.

An example workflow using this digital distribution process is:
1. A user 301 signs into the platform provider 302, preferably with their wallet,
2. The user 301 uploads a song and artwork to the platform provider, preferably via the preferred signed link method as described above,
3. The user 301 selects a distribution plan, and the platform provider 302 mints tokens and sends the song to various distribution outlets.

Preferably, the distribution plan sets out which distribution outlets the song will be available on as well as the number and kind of tokens generated. For example, where an album is provided through this process, tokens could be generated for individual songs, sets of songs, or the whole album, as well as any other digital content associated with the album such as a cover, back, other art, or lyrics. The distribution plan selects what content is tokenised and how.

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

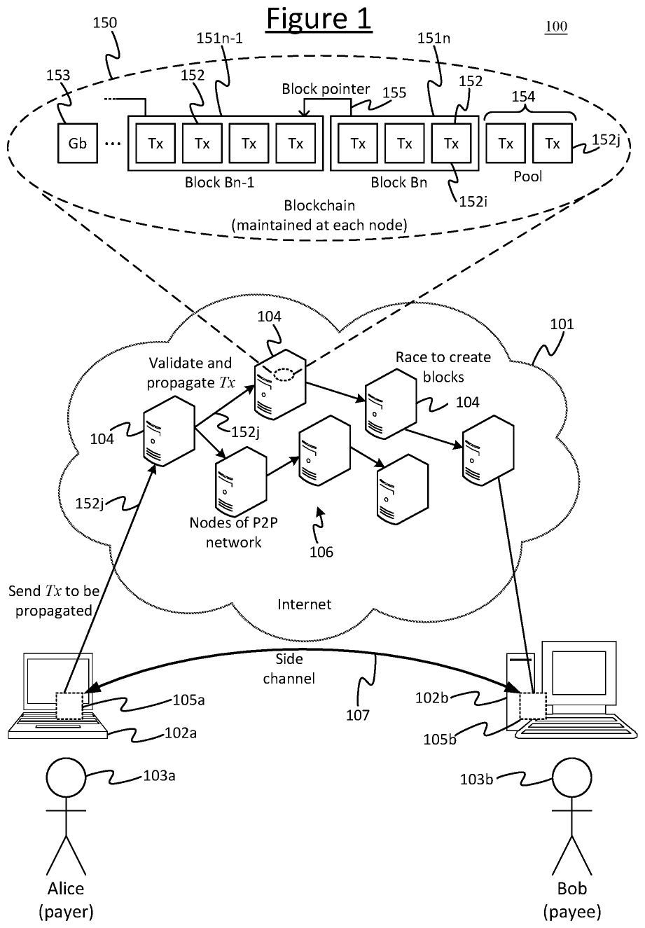

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. Optionally, the data field comprises data relating to a token as set out in the present application. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

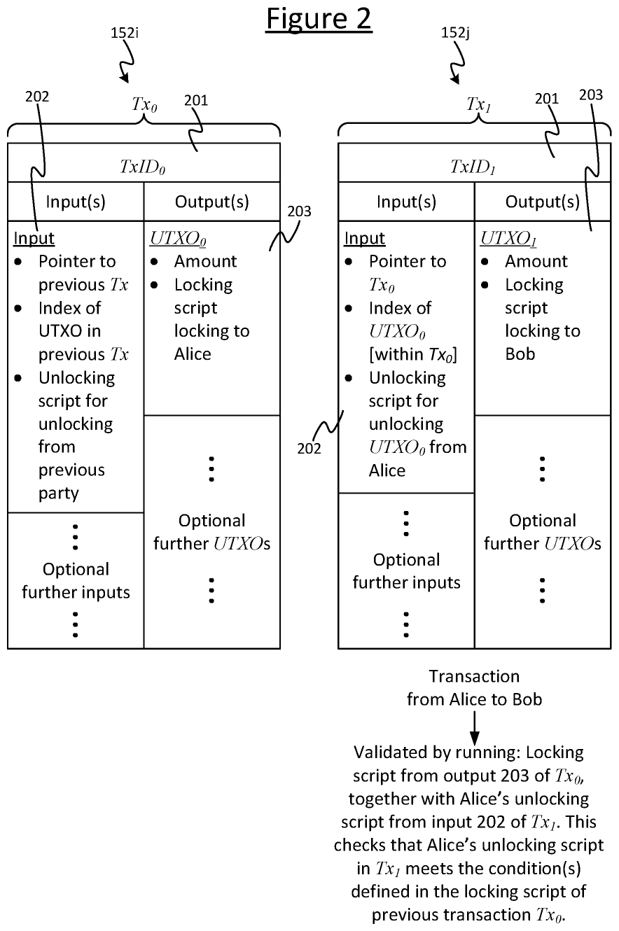

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₀ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above. Similarly, while a UTXO based blockchain model is provided as a specific example throughout, a person skilled in the art will appreciate that an account based blockchain may similarly be used.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.
Statement 1. A computer-implemented method of issuing tokens using a blockchain, wherein the method is performed by a platform provider and comprises:
   obtaining, from an authorised user, a digital content item;
   arranging for the storage the digital content item and/or sending the digital content item to a storage provider for storage by the storage provider;
   generating one or more digital tokens, each digital token comprising data representing and/or associated with the digital content item;
   arranging for the submission of one or more transactions to a blockchain, each transaction comprising data associated with a respective one of said one or more digital tokens;
   providing an online platform to users to view, purchase, trade and/or sell the one or more digital tokens.
Statement 2. The method of statement 1, wherein said obtaining of the digital content item comprising obtaining the digital content item via the online platform.
Statement 3. The method of statement 1 or statement 2, comprising:
   performing one or more of the following detection processes on the digital content item:
      antivirus detection,
      copyright infringement detection,
      illegal content detection,
   wherein generation of the one or more digital tokens is conditional on the one or more detection processes.
Statement 4. The method of any preceding statement, wherein said generating one or more digital tokens is conditional on:
   receiving a payment, via the online platform, from the authorised user; and/or
   performing an identity verification of the authorised user.
Statement 5. The method of statement 4, wherein said payment is received via a blockchain wallet application.
Statement 6. The method of any preceding statement, comprising:
   obtaining, from the authorised user, image and/or video data associated with the digital content item;
   storing the image and/or video data and/or sending the image and/or video data to the storage provider for storage by the storage provider; and
   associating, one the online platform, the image and/or video data with the one or more digital tokens.
Statement 7. The method of any preceding statement, comprising:
   receiving a request, via the online platform, from a requesting user to purchase a digital token; and
   submitting a further transaction to the blockchain, the transaction comprising data indicative of changing ownership of the digital token such that the requesting user is made the owner of the digital token.
Statement 8. The method of statement 7, wherein the further transaction comprises an output comprising the digital token and being locked to a public key of the requesting user and/or the platform provider.
Statement 9. The method of statement 7 or statement 8, comprising providing access, to the requesting user, to the digital content item, or authorising the storage provider to provide access to the digital content item.
Statement 10. The method of statement 9, wherein access is provided via the online platform.
Statement 11. The method of statement 9 or statement 10, comprising sending the digital content item to the requesting user.
Statement 12. The method of any of statements 7 to 11, wherein said submitting of the transaction is conditional on receiving a payment, via the online platform, from the requesting user.
Statement 13. The method of any of statements 7 to 12, comprising providing, via the online platform, a payment to the authorised user in response to the request.
Statement 14. The method of any preceding statement, wherein the digital content item is stored in cloud storage.
Statement 15. The method of any preceding statement, wherein the digital content item comprises multiple items.
Statement 16. The method of any preceding statement, wherein the digital content item comprises one of: an image file, an audio file, a video file.
Statement 17. The method of any preceding statement, wherein the step of arranging for the storage the digital content item and/or sending the digital content item to the storage provider for storage by the storage provider comprises:
   providing an upload link to the authorised user, such that the authorised user is able to upload the digital content item to the storage provider for storage.
Statement 18. The method according to statement 17, the step of arranging for the storage the digital content item and/or sending the digital content item to the storage provider for storage by the storage further comprises the step of:
   obtaining the upload link from the storage provider, and
   signing the upload link.
Statement 19. The method according to statement 17 or 18, wherein the step of obtaining the digital content item comprises:
   obtaining or receiving a notification from the storage provider that upload of the digital content item has completed, and
   accessing the digital content item from the storage provider.
Statement 20. The method of any preceding statement, wherein the identifier of the authorised user is, or is based on, a public key of the authorised user, and preferably wherein the public key is associated with a private key controlled only by the authorised user.
Statement 21. The method of any preceding statement, wherein each transaction comprises one or more outputs, each output comprising a respective one of said one or more digital tokens and being locked to a public key of the authorised user and/or the platform provider.
Statement 22. The method of any preceding statement, wherein the arranging of the submission of one or more transactions comprises: submitting the one or more transactions to the blockchain.
Statement 23. The method of any preceding statement, further comprising the step of: providing the digital content to a distribution outlet.
Statement 24. The method according to statement 23, wherein the provision of the digital content to distribution outlets is based on a distribution plan selected by the authorised user.
Statement 25. Computer equipment comprising:
   memory comprising one or more memory units; and
   processing apparatus comprising one or more processing units, wherein the memory stores code arranged to run on the processing apparatus, the code being configured so as when on the processing apparatus to perform the method of any of statements 1 to 24.
Statement 26. A computer program embodied on computer-readable storage and configured so as, when run on one or more processors, to perform the method of any of statements 1 to 24.
Statement 27. A computer implemented system comprising:
   a platform processor configured to conduct the method of any one of statements 1 to 24,
   an authorised user configured to provide a digital content item to the platform processor for minting of the digital content item into a token.
Statement 28. The computer implemented system of statement 27, wherein the authorised user is configured to provide the digital content item to the platform processor through use of a storage provider.

According to another aspect disclosed herein, there may be provided a method comprising the actions of the platform provider and the authorised user. According to another aspect disclosed herein, there may be provided a system comprising the computer equipment of the platform provider and the authorised user.

1. A computer-implemented method of issuing tokens using a blockchain, wherein the method is performed by a platform provider and comprises:
obtaining, from an authorised user, a digital content item;
arranging for storage of the digital content item and/or sending the digital content item to a storage provider for storage by the storage provider;
generating one or more digital tokens, each digital token comprising data representing and/or associated with the digital content item;
arranging for submission of one or more transactions to a blockchain, each transaction comprising data associated with a respective one of said one or more digital tokens;
providing an online platform to users to view, purchase, trade and/or sell the one or more digital tokens.

2. The method of claim 1, wherein said obtaining of the digital content item comprising obtaining the digital content item via the online platform.

3. The method of claim 1, comprising:
performing one or more detection processes on the digital content item, wherein the one or more detection processes include one or more of:
antivirus detection,
copyright infringement detection,
illegal content detection,
wherein generation of the one or more digital tokens is conditional on the one or more detection processes.

4. The method of claim 1, wherein said generating the one or more digital tokens is conditional on:
receiving a payment, via the online platform, from the authorised user; and/or
performing an identity verification of the authorised user.

5. The method of claim 4, wherein said payment is received via a blockchain wallet application.

6. The method of claim 1, comprising:
obtaining, from the authorised user, image and/or video data associated with the digital content item;
storing the image and/or video data and/or sending the image and/or video data to the storage provider for storage by the storage provider; and
associating, one the online platform, the image and/or video data with the one or more digital tokens.

7. The method of claim 1, comprising:
receiving a request, via the online platform, from a requesting user to purchase a digital token; and
submitting a further transaction to the blockchain, the transaction comprising data indicative of changing ownership of the digital token such that the requesting user is made owner of the digital token.

8. The method of claim 7, wherein the further transaction comprises an output comprising the digital token and being locked to a public key of the requesting user and/or the platform provider.

9. The method of claim 7, comprising providing access, to the requesting user, to the digital content item, or authorising the storage provider to provide access to the digital content item, wherein access is provided via the online platform.

10. The method of claim 7, wherein said submitting of the transaction is conditional on receiving a payment, via the online platform, from the requesting user.

11. The method of claim 7, comprising providing, via the online platform, a payment to the authorised user in response to the request.

12. The method of claim 1, wherein the step of arranging for the storage the digital content item and/or sending the digital content item to the storage provider for storage by the storage provider comprises:
providing an upload link to the authorised user, such that the authorised user is able to upload the digital content item to the storage provider for storage.

13. The method of claim 12, the step of arranging for the storage the digital content item and/or sending the digital content item to the storage provider for storage by the storage further comprises the step of:
obtaining the upload link from the storage provider, and
signing the upload link.

14. The method of claim 12, wherein the step of obtaining the digital content item comprises:
obtaining or receiving a notification from the storage provider that upload of the digital content item has completed, and
accessing the digital content item from the storage provider.

15. The method of claim 1, wherein each transaction comprises one or more outputs, each output comprising a respective one of said one or more digital tokens and being locked to a public key of the authorised user and/or the platform provider.

16. The method of claim 1, further comprising the step of:
providing the digital content to a distribution outlet.

17. The method of claim 16, wherein the provision of the digital content to distribution outlets is based on a distribution plan selected by the authorised user.

18. Computer equipment comprising:
memory comprising one or more memory units; and
processing apparatus comprising one or more processing units, wherein the memory stores code arranged to run on the processing apparatus, the code being configured so as when on the processing apparatus to perform the method of:
obtaining, from an authorised user, a digital content item;
arranging for storage of the digital content item and/or sending the digital content item to a storage provider for storage by the storage provider;
generating one or more digital tokens, each digital token comprising data representing and/or associated with the digital content item;
arranging for submission of one or more transactions to a blockchain, each transaction comprising data associated with a respective one of said one or more digital tokens;
providing an online platform to users to view, purchase, trade and/or sell the one or more digital tokens.

19. A computer program embodied on computer-readable storage and configured so as, when run on one or more processors, to perform the method of:
obtaining, from an authorised user, a digital content item;
arranging for storage of the digital content item and/or sending the digital content item to a storage provider for storage by the storage provider;
generating one or more digital tokens, each digital token comprising data representing and/or associated with the digital content item;
arranging for submission of one or more transactions to a blockchain, each transaction comprising data associated with a respective one of said one or more digital tokens;
providing an online platform to users to view, purchase, trade and/or sell the one or more digital tokens.

20. A computer implemented system comprising:
a platform processor configured to conduct a method of:
obtaining, from an authorised user, a digital content item;
arranging for storage of the digital content item and/or sending the digital content item to a storage provider for storage by the storage provider;
generating one or more digital tokens, each digital token comprising data representing and/or associated with the digital content item;
arranging for submission of one or more transactions to a blockchain, each transaction comprising data associated with a respective one of said one or more digital tokens;
providing an online platform to users to view, purchase, trade and/or sell the one or more digital tokens; and
an authorised user configured to provide a digital content item to the platform processor for minting of the digital content item into a token.
